(19) United States
(12) Patent Application Publication
(10) Pub. No.: US 2007/0131724 A1
(43) Pub. Date: Jun. 14, 2007

(54) Divot and ball mark repair apparatus

(76) Inventor: Glen White, Londonderry, NH (US)

Correspondence Address: THOMAS P. GRODT;FOREMAN CORCORAN TORR GRODT & GERRIN, PA, P. O. BOX 1330, 74 GILCREST ROAD, LONDONDERRY, NH, 03053, US

(21) Appl. No.: 11/302,585

(22) Filed: Dec. 14, 2005

(51) Int. Cl. B67D 3/00; B67D 5/64

(52) U.S. Cl. 222/510; 222/175

(57) ABSTRACT

A divot and ball mark repair apparatus is disclosed that two hollow elongated member coaxially positioned. The space between the two members forms a volume that a repair/replacement mixture that may include sand; sand and seed; or a mixture of sand, seed, and fertilizer mixture is placed. The outer member includes first and second ends in which each end has a corresponding opening to allow the mixture to be placed into the volume and dispensed respectively. A chamber that has a movable bottom surface is located at the bottom of the first member and is activated by a spring biased mechanism disposed within the second member. The spring bias mechanism allows a user to displace the bottom of the chamber away from the other sides of the chamber and dispense the mixture therein into a divot hole or other bare spot.

### BACKGROUND

This invention relates generally to portable dispensers and more particularly to a device for dispensing sand or a mixture of sand and seed or a mixture of sand, seed, and fertilizer for use in repairing divots or ball marks on golf courses.

It is an inherent aspect of the game of golf that when hitting their ball golfers often take a piece of turf in addition to hitting their ball. This piece of turf is commonly referred to as a divot and the hole as a divot hole. In other situations, when the ball lands on a green, a ball mark may be made in the green disturbing the contour of the green and making putting more difficult. Good golf course maintenance requires an effective means for repairing the ground that these divots were taken from. In certain types of grasses the divot may be replaced by the golfer and will grow back, effectively repairing itself, in a reasonably short period of time. Other types of grasses, for example certain bent and Bermuda grasses, the divots do not tend to grow back and will die, even if replaced. It is therefore recommended that the golfer not replace their divots.

In these situations, golf carts are equipped with a bucket or other open container filled with a sand, or sand and dirt, mixture and a scoop that is used to spread the seed and dirt mixture over the bare spot left by the divot or the depression left by the ball mark on the green. In addition, maintenance crews equipped with a bucket of sand or sand/soil mixture may scoop out small amounts of the mixture onto the mark to smooth the surface and speed up the healing process. However, either of these alternatives may be time consuming and may therefore slow down play resulting in longer play times and allowing fewer players to play on a given day. In addition, the scoop requires players to bend over at the waist to fill the divot holes and this physical motion may discourage the players from filling their divot holes.

### SUMMARY

A divot or ball mark repair apparatus is disclosed that includes a first hollow elongated member having first and second ends in which each end has a corresponding opening to allow a mixture to be added and dispensed respectively. The divot and ball mark repair apparatus also includes a second hollow elongated member, coaxially disposed within the first hollow elongated member. The space between the first and second members forms a first interior volume. The mixture of sand, sand/seed, sand/seed/fertilizer mixture can be loaded into the interior volume via the first opening and dispensed from the interior volume via the second opening. A removable cap covers the first opening has a coaxial opening and is affixed to the first end of the first member. A rod is disposed within said second hollow elongated member and has a first end extending through the hole in the removable cap and is able to move in a sliding manner within the second elongated member. A spring biased cap is affixed to the first end of the rod. A spring mechanism is used to bias the spring biased cap away from the removable cap.

A second chamber is formed by one or more side portions and a release plate forming the bottom of the chamber that defines a chamber volume and the chamber itself is placed at the bottom end of the first elongated member. The chamber includes a hole that is sized and placed to receive the rod through it. The rod extends into the chamber and is affixed to the release plate. In this way, when the spring mechanism biases the rod upward, the release plate is also moved upward, meets the one or more chamber sides, and encloses the chamber. When the rod is moved downward by a user, the release plate is pushed away from the one or more sides and opens the chamber and allows the mixture to be dispensed through the second opening of the first elongated member. The chamber may be refilled via at least one aperture within the one or more sides that allows communication between the interior volume and the chamber interior volume.

In another aspect of the divot and ball mark repair apparatus, it may also include a support frame affixed to the second end of the first elongated member. The support frame has an opening aligned with the second opening of the first elongated member. In this way, as the mixture dispensed from the second opening is allowed to fall through the support frame and into the divot hole.

The divot and ball mark repair apparatus may also include a nozzle output in which the second opening includes a nozzle assembly in which a nozzle side portion reduces the diameter of the second opening from the diameter of the release plate to a nozzle outlet having a desired diameter.

In order to prevent lateral movement of the rod, the divot and ball mark repair apparatus can also include a bushing assembly that includes a bushing disposed within the hole of the removable cap and affixed thereto to prevent movement of the bushing. The bushing is sized and configured to receive the rod and allow it to pass through the interior of the bushing. The bushing may further include an external thread suitable to mate with an internal thread within the hole. In this embodiment, a first nut that is sized and configured to be threaded on the bushing is threaded onto the external threads of the bushing external to the removable cap. If needed, a second nut that is sized and configured to be threaded on the bushing is threaded onto the external threads of the bushing within the first interior volume. In this way, the first and second nuts substantially prevent motion of the bushing within the hole. The bushing may also include an internal thread that is operative to receive a nut having complimentary external threads. The nut has a center opening sized and configured to receive the rod through it and not interfere with any movement of the rod.

In one embodiment, the spring mechanism of the divot and ball mark repair apparatus is a helical spring that is placed about the part of the rod that extends through the hole in the removable cap. The spring presses against the bottom surface of the spring biased cap and the top surface of the removable cap to outwardly bias the spring biased cap.

In one embodiment, the release plate includes a hole that is sized to receive the bottom portion of the rod. The release plate is placed at the bottom portion of the elongated member. In this embodiment, the bottom portion of the rod includes external threads and the release plate is affixed to the rod using either internal threads formed on the interior of the hole, using first and second nuts being sized and configured to have internal threads complimentary to the external threads on the bottom portion of the rod, a combination of internal threads and a nut, being press fit, welded, or any other suitable joining mechanism. The first and second nuts are placed on the threaded portion of the rod on opposite sides of the release plate. In this way to the two nuts hold the release plate in place and substantially prevent movement by the release plate along the length of the rod.

### BRIEF DESCRIPTION OF DRAWINGS

These and other features, aspects, and advantages of the present invention will become better understood with regard to the following description, appended claims, and accompanying drawings. The drawings are not necessarily to scale, emphasis instead being placed on illustration of principles of the invention. The drawings include the following figures:

FIG. 1 is a front view in elevation of an embodiment of the present invention;

FIG. 2 is a sectional view of an embodiment of the present invention; and

FIG. 3 is a cross sectional view along line 3-3 in FIG. 1.

### DETAILED DESCRIPTION

The present invention may be understood by the following detailed description, which should be read in conjunction with the attached drawings. The following detailed description of certain embodiments is by way of example only and is not meant to limit the scope of the present invention.

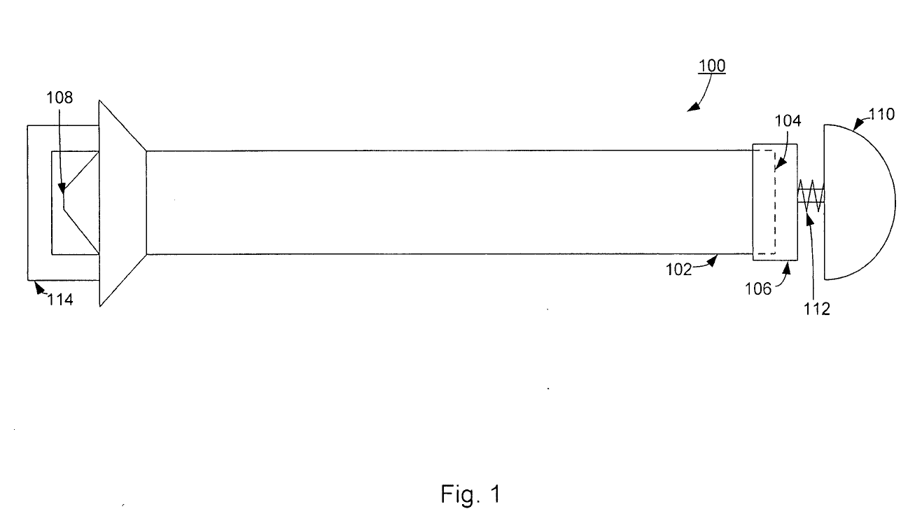

FIG. 1 depicts an embodiment of the divot and ball mark repair apparatus 100 suitable for repairing divots and ball marks on a golf course, or bare spots in a lawn or other grassy area, with a suitable repair/replacement mixture. The mixture is contained within a first chamber (not shown in FIG. 1) that is within a portion of the interior space of a first hollow elongated member 102. The mixture may be added to the first chamber via a suitable opening or input nozzle that allows communication between the exterior of the elongated member 102 and the first chamber. The elongated member 102 may have an open end 104 that is covered by cap 106 so that the elongated member 102 is enclosed on that end to prevent the mixture from spilling. The cap 106 may be removable and may be affixed in a suitable manner to the member 102, e.g., via a threaded connection or by being press-fit. In one embodiment, a notch 105 in cap 106 allows the mixture to be added to the first chamber. In another embodiment, the apparatus 100 may include an input nozzle 116 that allows mixture to be added to the first chamber and is sized and dimensioned appropriately to allow the mixture to be added easily. The input nozzle 116 may be disposed on and through the elongated member 102 at a convenient location or disposed on and through the cap 106. The nozzle 116 includes a mixture inlet 118 having an opening 119 that allows the mixture to be added to the first chamber of the elongated member 102. In another embodiment, the elongated member 102 may be sealed at one end and therefore not in need of cap 106 but will need the input nozzle 116 provided as described above for placing the mixture in the first chamber.

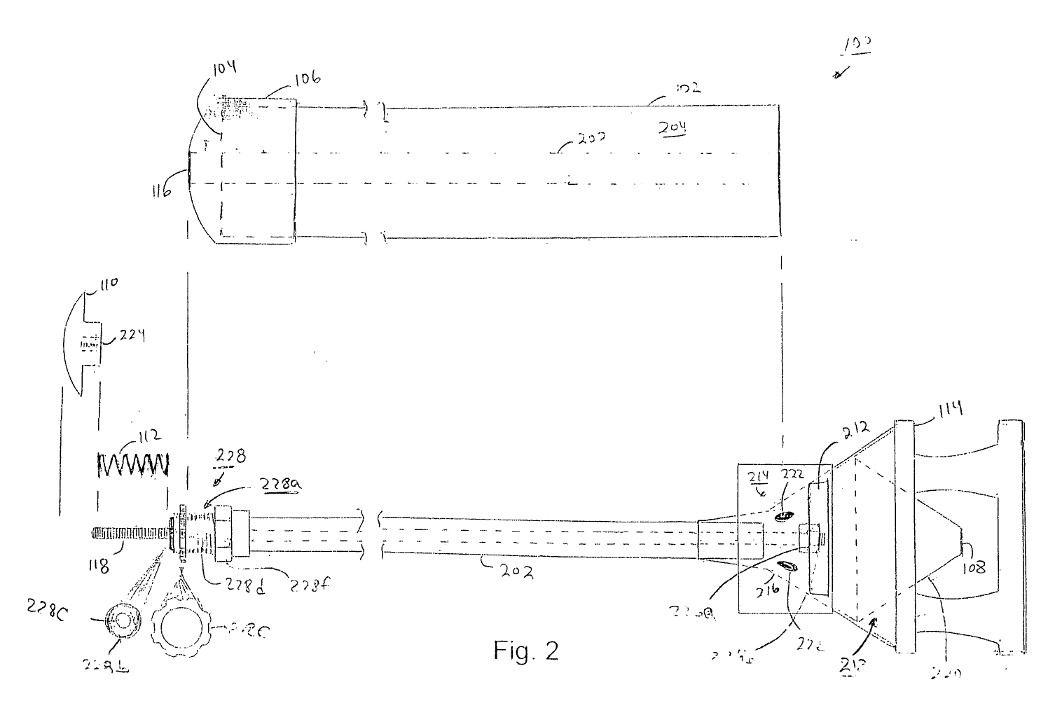

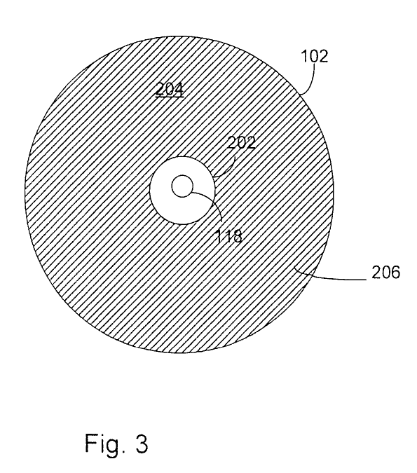

FIGS. 2 and 3 depict an exploded view of the divot and ball mark repair apparatus 100. The divot and ball mark repair apparatus 100 further includes a second hollow elongated member 202 disposed coaxially within the first hollow elongated member 102. The interior volume 204 defined by the inner surface of the first member 102 and the outer surface of the second member 202 forms a first chamber 224 in which the repair/replacement mixture 206 is placed.

The rod 120 is disposed within the second hollow elongated member 202 and extends through a hole 122 in the cap 106. The rod 120 is free to slide within the second member 202 and is affixed within a via 224 formed in the base of the spring biased cap 110 by a suitable method such as complimentary threads, a suitable adhesive, or by being press-fit. The spring 112 is disposed between the top of the cap 106 and the bottom of the spring-biased cap 110 and is configured and arranged to bias the spring-biased cap 110 away from the cap 106. The spring 112 may be any suitable spring mechanism and in one embodiment the spring 112 is a helical spring coaxially disposed about the rod 116 between the top of the removable cap 106 and the bottom of the spring biased cap 110.

The other end of the rod 120 extends through the bottom of the second elongated member 202 where it is affixed to a release plate 212. The release plate 212 forms the bottom of a second chamber 214 having a chamber interior volume defined by the release plate 212 and the interior side of chamber wall 216. Although the chamber wall 216 is depicted as a pyramid shape the chamber wall 216 may be any shape that forms a chamber 214 of a desired volume. For example, semispherical, cubical, or other suitable geometric volumes may be formed by chamber wall 216. The second chamber 214 interior volume is selected to provide the desired volume of mixture to be dispensed. The volume selected will be a function of the repair apparatus. For example for repairing divot holes the volume of mixture may be a function of the type of grass, the type of soil, and the general weather conditions in which the divot and ball mark repair apparatus is to be used. In the event that the function of the repair apparatus is to repair ball marks on a green, the volume selected will be a function of the average size of ball marks on a particular course. Apertures 222 through the chamber wall 216 communicate between the first and second chambers 204 and 214, respectively, and allow the repair/replacement mixture to enter and substantially fill the second chamber 214 from the first chamber 204. The apertures may be any suitable number and shape to allow the mixture to refill the chamber 214.

As discussed above, the release plate 212 is affixed to the rod 118 and is moveable by the rod 118. When the rod 118 is in the biased condition, i.e., when the cap 110 is biased by the spring away from cap 106, the release plate is brought into physical contact with chamber wall 216 enclosing the second chamber interior volume and preventing the dispensing of any mixture. When the spring-biased cap 110 is depressed against the force of the spring 112 the rod 118 moves in a slidable motion downward and displaces the release plate 212 away from chamber wall 216. This allows the mixture within the second chamber to communicate with the mixture outlet 108 such that the mixture falls from the second chamber through the outlet 108 and onto the ground. The chamber interior volume then refills with mixture 206 from the first chamber 224 via the one or more apertures 222.

As depicted, mixture outlet 108 may be the outlet for a nozzle assembly 218 that includes walls 220 that reduce the diameter of the outlet from the diameter of the chamber 214 to the desired diameter of mixture outlet 108. In this way, the mixture that is dispensed is dispensed in a tighter pattern, thereby reducing the amount of mixture that misses the divot hole and thereby increasing the efficiency of the present divot and ball mark repair apparatus.

In a preferred embodiment, the elongated member 102 has a length sufficiently long to allow a person to use the divot and ball mark repair apparatus 100 without having to bend at the waist. This would advantageously provide an increased ease of use when compared to the prior be described above in which the golfer or maintenance person would have to bend down to repair a ball mark or divot hole. In operation, a person places the frame 114 on the ground such that the mixture outlet 108 of the divot and ball mark repair apparatus 100 is adjacent to or within a divot hole or ball mark. The user presses down on the spring biased cap 110 that is coupled to the rod 118 so that the rod move in a linear motion and displaces the release plate at the bottom end of the chamber 214 to dispense a predetermined amount of the repair/replacement mixture into the divot hole or bare spot via the mixture outlet 108. The frame 114 is made of a suitably strong material to allow the user to press down on the spring biased cap 110 with sufficient force to displace the release plate.

In the embodiment depicted in FIG. 2, the rod 120 is a threaded rod that is threadably received by a complimentary threaded via 224 in the spring-biased cap 110. The threaded rod depicted in FIG. 2 is received by a hole in the release plate 212 and held in place by a pair of nuts 226a and 226b. In addition as depicted in FIG. 2 a bushing assembly 228 is provided to maintain the rod 118 in a vertical orientation and to prevent lateral movement of the rod during operation. The bushing assembly includes a bushing 228a that receives the threaded rod 118 and via a threaded nut 228b that includes external threads that are complimentary to the internal threads of busing 228a. The threaded nut further includes a center hole 228c that is sized and configured to receive the rod 118 therethrough. The bushing 228a also includes external threads 228d that are received by complimentary threads within the hole 122. A nut 228e is disposed on the external threads 228d and external to the hole 122 and is used to prevent movement of the bushing assembly 228. Alternatively, the hole 122 is not threaded and the bushing 228a is affixed within the hole 116 by the nut 228e and a second nut 228f on the bushing 228a.

The repair/replacement mixture that is used depends upon whether divot holes or ball marks are being repaired. In the case of repairing ball marks, the mixture may be comprised of sand or other fine granular material, which may be colored. For repairing divot hoes a sand and grass seed mixture or a mixture of sand, grass seed, and fertilizer mixture may be used. In addition, for either repairing divot holes or ball marks the sand may include a combination of dirt and sand or dirt may be substituted for the sand.

While the present invention has been particularly shown and described with references to preferred embodiments thereof, it will be understood by those skilled in the art that various changes in form and details may be made therein without departing from the spirit and scope of the invention as defined by the appended claims. All the features disclosed in this specification, including any accompanying claims, abstract, and drawings, may be replaced by alternative features serving the same, equivalent or similar purpose, unless expressly stated otherwise.

What is claimed is:

1. A divot and ball mark repair apparatus for dispensing a repair/replacement mixture, comprising:
a first hollow elongated member having first and second ends, the first and second ends having a corresponding opening, the opening in the first end being coaxially located in said first hollow elongated member;
a second hollow elongated member coaxially disposed within the first hollow forming a first chamber between the first and second members;
a rod slidably disposed within said second hollow elongated member and having a first end extending through the opening in the first end;
a spring-biased cap affixed to the first end of the rod;
a spring mechanism configured and arranged to bias the spring-biased cap away from the first end of the first elongated member
a chamber wall disposed within the first hollow elongated member and configured and arranged to form a second chamber within the first chamber, the chamber wall including a coaxially disposed opening sized and dimensioned to receive the rod therethrough, the chamber wall further including at least one aperture that allows communication between the second chamber and the first chamber;
a release plate affixed to the rod and moveable thereby, the release plate forming the bottom of the second chamber, the second chamber having a chamber interior volume defined by the chamber wall and the release plate, the second chamber being disposed toward the bottom end of the first chamber; the release plate being biased by the rod to press against the chamber wall and thereby enclose the second chamber; the release plate moveable by the rod and the rod being operative to move the release plate away from the chamber wall and open the second chamber and allow communication between the second chamber interior volume and the second opening of the first elongated member.

2. The divot and ball mark repair apparatus of claim 1 further including a support frame affixed to the second end of the first elongated member and having an opening aligned with the second opening of the first elongated member, wherein the mixture dispensed from the second opening is allowed to fall through the support frame.

3. The divot and ball mark repair apparatus of claim 1 wherein the second opening includes a nozzle assembly in which a nozzle side portion reduces the diameter of the second opening from the diameter of the release plate to a nozzle outlet having a desired diameter.

4. The divot and ball mark repair apparatus of claim 1 further comprising a bushing assembly including a bushing disposed within the opening in the first end, the bushing being sized and configured to receive the rod therethrough.

5. The divot and ball mark repair apparatus of claim 4 wherein the bushing further includes an external thread suitable to be received by a complimentary thread internal to the opening in the first end and a first nut sized and configured to be threaded on the bushing external to the opening in the first end and a second nut sized and configured to be threaded on the bushing within the first interior volume, wherein the first and second nuts are operative to substantially prevent motion of the bushing within the hole.

6. The divot and ball mark repair apparatus of claim 4 wherein the bushing further includes an internal thread that is operative to receive a nut having complimentary external threads, the nut having a center opening sized and configured to slidably receive the rod therethrough.

7. The divot and ball mark repair apparatus of claim 1 wherein the spring mechanism is a helical spring disposed about the portion of the rod extending through the hole in the removable cap and disposed between a bottom surface of the spring-biased cap and a top surface of the removable cap.

8. The divot and ball mark repair apparatus of claim 1 wherein the release plate includes a hole therein sized and configured to receive a bottom portion of the rod, the bottom portion of the rod including external threads and wherein the release plate is affixed to the rod via first and second nuts being sized and configured to have internal threads complimentary to the external threads on the bottom portion of the rod, the first and second nuts being disposed on the threaded portion of the rod on each side of the release plate, wherein the first and second nuts are operative to substantially prevent movement of the release plate along the length of the rod.

9. The divot and ball mark repair apparatus of claim 1 further including an input nozzle having a mixture inlet and outlet, the outlet being aligned with an opening in the wall of the first elongated member to allow communication between the exterior of the first elongated member and the first chamber.

10. The divot and ball mark repair apparatus of claim 1 wherein the first end of the first elongated member is open and further including a cap disposed over the first end of the first elongated member, the cap having a center hole thererthrough, the cap further including an input aperture offset from the center of the cap and extending therethrough to enable communication between the exterior of the first elongated member and the first chamber.

11. The divot and ball mark repair apparatus of claim 10 further including an input nozzle having a mixture inlet and outlet, the mixture outlet being aligned with the input aperture in the cap to allow communication between the exterior of the first elongated member and the first chamber.

12. The divot and ball mark repair apparatus of claim 1 wherein the repair/replacement mixture is sand.

13. The divot and ball mark repair apparatus of claim 1 wherein the repair/replacement mixture is colored sand.

14. The divot and ball mark repair apparatus of claim 1 wherein the repair/replacement mixture is a mixture of sand and grass seed.

15. The divot and ball mark repair apparatus of claim 1 wherein the repair/replacement mixture is a mixture of sand, grass seed, and fertilizer.

16. The divot and ball mark repair apparatus of claim 1 wherein the second chamber is substantially cubic in shape.

17. The divot and ball mark repair apparatus of claim 1 wherein the second chamber is substantially pyramidal in shape.

18. The divot and ball mark repair apparatus of claim 1 wherein the second chamber is spherical in shape.
